(19) United States
(12) Patent Application Publication
(10) Pub. No.: US 2012/0298453 A1
(43) Pub. Date: Nov. 29, 2012

(54) VIBRATION DAMPING APPARATUS FOR ELEVATOR CAR

(75) Inventors: Satoshi FUJII, Tokyo (JP); Yosuke Murao, Tokyo (JP); Tsutomu Mishiro, Tokyo (JP)

(73) Assignee: TOSHIBA ELEVATOR KABUSHIKI KAISHA

(21) Appl. No.: 13/307,538

(22) Filed: Nov. 30, 2011

(30) Foreign Application Priority Data
Nov. 30, 2010 (JP) 2010-267050

(51) Int. Cl. B66B 13/12

(52) U.S. Cl. 187/330

(57) ABSTRACT

According to one embodiment, a vibration damping apparatus for an elevator car includes an engaging apparatus, an interlocking mechanism, and a friction generation mechanism. The engaging apparatus includes a pair of engaging vanes. A gap between the vanes is narrowed when the car door apparatus is opened. The interlocking mechanism includes a lock lever and an engaging body, is released by an action of the engaging vanes holding the engaging body, and interlocks the hall door apparatus with operation of the car door apparatus. The friction generation mechanism generates a frictional force between the engaging vanes and the engaging body for suppressing a vertical vibration of the car when the engaging vanes are in a state of holding the engaging body.

### CROSS-REFERENCE TO RELATED APPLICATIONS

This application is based upon and claims the benefit of priority from prior Japanese Patent Application No. 2010-267050, filed Nov. 30, 2010, the entire contents of which are incorporated herein by reference.

### FIELD

Embodiments described herein relate generally to a vibration damping apparatus that damps vertical vibrations of an elevator car caused when passengers get on and off the car after the elevator car arrives at a floor of an elevator hall.

### BACKGROUND

In an elevator, a car and a counterweight are suspended in an elevator shaft of a building. The car and the counterweight are suspended in the elevator shaft by a main rope that is wound around a traction machine, and move in directions opposite to each other in the elevator shaft in a vertical direction by a driving force of the traction machine. The car and the counterweight move along guide rails individually provided therefore.

An elevator hall at each floor of a building is provided with a doorway for a passenger to get on and get off the car. A hall door apparatus of a sliding type is installed at the doorway. The hall door apparatus is normally closed and driven by a driving force of a car door apparatus of the car when the car arrives at a floor and stops. The hall door apparatus is provided with an interlocking mechanism. The interlocking mechanism locks the hall door apparatus when it is closed, and unlocks the hall door apparatus prior to start door opening operation.

An engaging apparatus that transfers the driving force of the car door apparatus to the hall door apparatus and operates the interlocking mechanism is provided between the car door apparatus and the hall door apparatus. This engaging apparatus includes a pair of engaging vanes provided in the car door apparatus. The pair of engaging vanes is placed to oppose each other and is configured to change a relative distance therebetween according to the operation of the car door apparatus.

The interlocking mechanism includes two engaging rollers as an engaging body to engage with the engaging apparatus. The two engaging rollers are interposed between the pair of engaging vanes while the car door apparatus opposes the hall door apparatus. When the car door apparatus starts the door opening operation, the distance between the pair of engaging vanes is narrowed in an interlocking manner with such operation and the engaging rollers are held therebetween. With this operation, the interlocking mechanism and the engaging apparatus engage with each other. The interlocking mechanism is operated by this engaging operation, and the hall door apparatus is unlocked. The car door apparatus and the hall door apparatus are coupled to each other when the engaging apparatus and the interlocking mechanism engage with each other. The car door apparatus and the hall door apparatus move together in a door opening direction.

When the car door apparatus moves in a door closing direction and the door is completely closed after passengers finish getting on and off the car, the distance between the pair of engaging vanes is widened, which produces a gap between the vanes and the engaging rollers. This makes the car ready to travel, and prevents the engaging vanes and the engaging rollers from making contact with each other while the car is traveling through a floor at which the car is not supposed to stop.

Incidentally, while the passengers get on and off the car, the car may sometimes vibrate vertically despite the fact that the car is at a stop at a floor. This vibration is mainly caused by a change in load added to the car by getting on and off of the passengers, thereby resulting elastic expansion and contraction of the main rope that suspends the car.

When the car vibrates vertically, the passengers in the car have unsteady, unstable, and weird feeling. Since some passengers may have fear, serviceability of the elevator decreases.

To eliminate the anxiety, there are some elevators equipping with a friction member on the car. It is considered that the friction member is pressed against the guide rail of the car by an action of an electromagnetic actuator when the car has been at a floor so that the vertical vibration of the car is suppressed by the frictional force.

However, when exclusive members such as an electromagnetic actuator for driving a friction member and a control device for the electromagnetic actuator are provided, the structure becomes complicated, and the cost is increased.

### BRIEF DESCRIPTION OF THE DRAWINGS

FIG. 1 is a front view illustrating an engaging apparatus of a car door apparatus, and an interlocking mechanism of a hall door apparatus according to a first embodiment;

FIG. 2 is a perspective view of the interlocking mechanism illustrated in FIG. 1;

FIG. 3 is a front view illustrating a state in which the engaging apparatus and the interlocking mechanism illustrated in FIG. 1 engage with each other;

FIG. 4 is a front view illustrating a state in which an engaging apparatus of a car door apparatus and an interlocking mechanism of a hall door apparatus according to a second embodiment engage with each other;

FIG. 5 is a front view illustrating a state in which the car door apparatus and the hall door apparatus illustrated in FIG. 4 are opened;

FIG. 6 is a front view of the interlocking mechanism illustrated in FIG. 4;

FIG. 7 is a side view of the interlocking mechanism illustrated in FIG. 6;

FIG. 8 is a front. view of an interlocking mechanism of a hall door apparatus according to a third embodiment;

FIG. 9 is a partially exploded perspective view of the interlocking mechanism illustrated in FIG. 8;

FIG. 10 is a front view illustrating an interlocking mechanism of a hall door apparatus according to a fourth embodiment;

FIG. 11 is a partially exploded perspective view of the interlocking mechanism illustrated in FIG. 10;

FIG. 12 is a front view illustrating a frictional force increasing mechanism according to a fifth embodiment;

FIG. 13 is a front view illustrating a frictional force increasing mechanism according to a sixth embodiment; and

FIG. 14 is a front view illustrating a frictional force increasing mechanism according to a seventh embodiment.

### DETAILED DESCRIPTION

In general, according to one embodiment, a vibration damping apparatus for an elevator car includes an engaging apparatus, an interlocking mechanism, and a friction generation mechanism. The engaging apparatus is provided in a car door apparatus and includes a pair of engaging vanes. A gap between the vanes is narrowed when the car door apparatus is opened, and widened when the car door apparatus is closed. The interlocking mechanism is provided in a hall door apparatus, includes a lock lever and an engaging body, is released by an action of the engaging vanes holding the engaging body when the car door apparatus starts opening, and interlocks the hall door apparatus with operation of the car door apparatus. The friction generation mechanism generates a frictional force between the engaging vanes and the engaging body for suppressing a vertical vibration of the car when the engaging vanes are in a state of holding the engaging body therebetween.

The vibration damping apparatus according to one embodiment utilizes an existing mechanism for operating the interlocking mechanism and for transferring a driving force of the car door apparatus to the hall door apparatus. With this arrangement, the vertical vibration of the car is suppressed easily and inexpensively.

In the vibration damping apparatus according to another embodiment, the engaging body includes a roller that is freely rotatable and held by the pair of engaging vanes therebetween. The friction generation mechanism includes a friction member that is provided in a portion making contact with a roller of at least one of the vanes, and generates a frictional force that suppresses the vertical vibration of the car between the engaging vanes and the roller through the friction member.

Alternatively, in the vibration damping apparatus according to another embodiment, the engaging body includes a roller that is freely rotatable and held by the pair of engaging vanes therebetween. The friction generation mechanism includes a material having a high coefficient of friction as a material constituting at least a surface of the roller, and generates a frictional force with the material for suppressing the vertical vibration of the car between the engaging vanes and the roller.

Further, in the vibration damping apparatus according to another embodiment, the engaging body includes a block-shaped friction member as a friction generation mechanism fitted to the interlocking mechanism. This friction member generates a frictional force for suppressing the vertical vibration of the car by being held by the engaging vanes therebetween.

In this case, the friction member is detachably fitted to the interlocking mechanism. The friction member is also swingably fitted to the interlocking mechanism.

Yet, in the vibration damping apparatus according to another embodiment, the engaging apparatus includes a guide roller, a guide rail, and a frictional force increasing mechanism. The guide roller is fitted to one of the engaging vanes. The guide rail guides the guide roller when the car door apparatus performs opening or closing operation. The frictional force increasing mechanism is provided to the guide rail and increases the frictional force between the engaging vanes and the engaging body when door opening operation of the car door apparatus completes.

In this case, the frictional force increasing mechanism includes a step provided to an end portion of the guide rail. The guide roller runs on the step upon completion of the door opening operation of the car door apparatus, then the frictional force between the engaging vanes and the engaging body increases. Alternatively, the frictional force increasing mechanism includes a slope provided at the end portion of the guide rail. The guide roller runs on the slope upon completion of the door opening operation of the car door apparatus, then the frictional force between the engaging vanes and the engaging body increases. Alternatively, the frictional force increasing mechanism includes a pressing apparatus arranged at the end portion of the guide rail. The pressing apparatus includes a push rod elastically biased by a spring. When the door opening operation of the car door apparatus completes, a force of the engaging vanes holding the guide roller therebetween is assisted by a biasing force of the push rod to thereby increase the frictional force between the engaging vanes and the engaging body.

Hereinafter, some embodiments will be described with reference to the drawings. In each of the embodiments described below, an element having identical functions will be identified with the same reference symbols, and the description of the corresponding embodiment is referred. In each of the embodiments, a side of an entrance of the car may sometimes be referred to as “front”, a back side thereof as “rear”, a side of the hall of the doorway of the elevator as “front side”, and a side of the elevator shaft of the doorway as “rear side”.

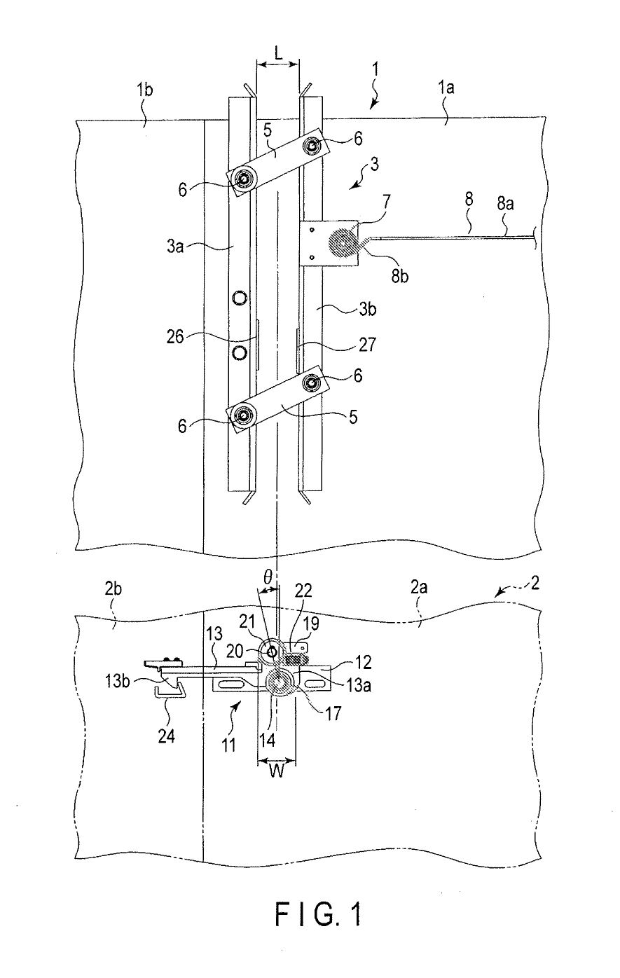

FIGS. 1 to 3 illustrate a first embodiment. FIG. 1 illustrates a car door apparatus 1 installed at an entrance of a car, and a hall door apparatus 2 installed at a doorway of each elevator hall. The car door apparatus 1 is installed at a front side of the car by a door frame member, and the hall door apparatus 2 is installed at a rear side of the doorway by a door frame member. FIG. 1 illustrates a state in which the car door apparatus 1 and the hall door apparatus 2 are vertically apart from each other.

The car door apparatus 1 is provided with a pair of door panels 1a and 1b, and includes a double-door structure in which the pair of door panels 1a and 1b move right and left to open or close the entrance of the car. The hall door apparatus 2 is provided with a pair of door panels 2a and 2b, and includes a double-door structure in which the pair of door panels 2a and 2b move right and left to open or close the doorway of the elevator hall.

The car door apparatus 1 is provided with a driving source such as a motor, and the door panels 1a and 1b are controlled to move in a door opening direction in which they move away from each other, and in a door closing direction in which they move closer to each other. Since the hall door apparatus 2 has a self-closing mechanism, the door panels 2a and 2b are elastically biased in the door closing direction in which they move closer to each other.

As illustrated in FIG. 1, one door panel 1a of the car door apparatus 1 is provided with an engaging apparatus 3. The engaging apparatus 3 includes a pair of engaging vanes 3a and 3b that elongate vertically. These engaging vanes 3a and 3b have a horizontal section in an L-shape. One engaging vane 3a is fixed to the door panel 1a. The other engaging vane 3b is arranged in parallel opposing to the one engaging vane 3a, and is coupled to the one engaging vane 3a with a plurality of link bars 5. One end portion of each link bar 5 is rotatably coupled to the one engaging vane 3a through a pin 6, and the other end portion of the link bar 5 is rotatably coupled to the other engaging vane 3b through a pin 6. When the link bar 5 rotates around the pin 6 of the one engaging vane 3a, the other engaging vane 3b moves maintaining in parallel to the one engaging vane 3a. Thus opposing gap L between the one engaging vane 3a and the other engaging vane 3b change.

The other engaging vane 3b has a guide roller 7 rotatably attached thereto. A guide rail 8 that covers a range in which the guide roller 7 moves along with the movement of the door panel 1a is provided horizontally to a door frame member supporting the car door apparatus 1. The guide rail 8 includes a horizontal portion 8a extending in a horizontal direction and an inclined portion 8b extending obliquely downward continuously from an end portion of the horizontal portion 8a located close to a center of the car door apparatus 1.

While the car door apparatus 1 is closed, the guide roller 7 makes contact with the inclined portion 8b of the guide rail 8. As a result, the engaging vane 3b is kept at a certain height. While the guide roller 7 makes contact with the inclined portion 8b of the guide rail 8, the gap L between the engaging vanes 3a and 3b is kept in wide.

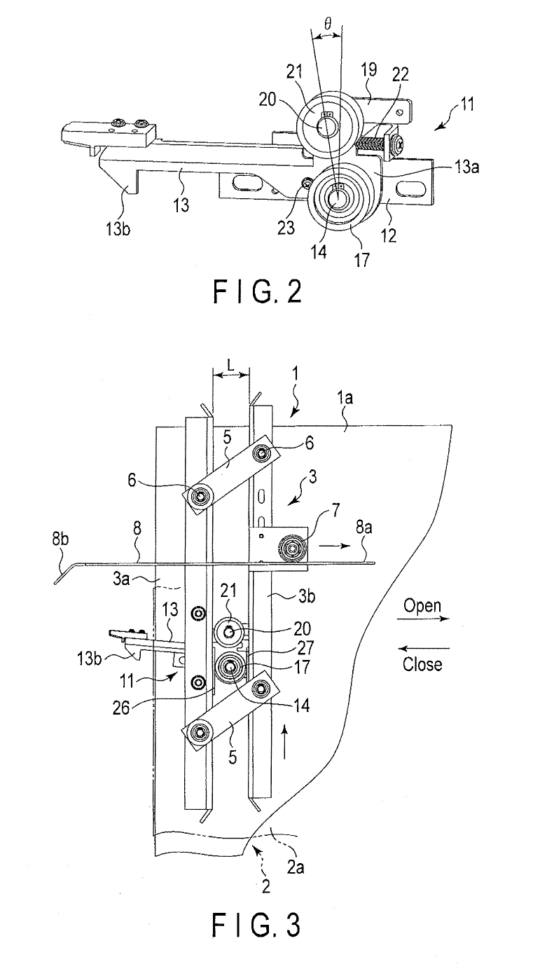

The hall door apparatus 2 includes an interlocking mechanism 11 that holds door in a closed state in which the two door panels 2a and 2b are coupled to each other. As illustrated in FIGS. 1 and 2, the interlocking mechanism 11 includes a base plate 12. The base plate 12 is fixed to the one door panel 2a of the hall door apparatus 2. A lock lever 13 is rotatably attached to the base plate 12 through a shaft 14.

The lock lever 13 has a proximal portion 13a rotatably coupled to the base plate 12 through the shaft 14, and an, engaging portion 13b having a hook shape formed on a tip side thereof that rotates. The proximal portion 13a incorporates therein a bearing that allows the lock lever 13 to rotate around the shaft 14. A roller 17 as an engaging body is rotatably attached to the shaft 14 that supports the lock lever 13. The proximal portion 13a of the lock lever 13 has an arm portion 19 formed integrally therewith and extending upward. The arm portion 19 includes a roller 21 as the engaging body which rotatably attached thereto through a shaft 20. A diameter of the roller 21 is slightly smaller than that of the roller 17.

The lock lever 13 has a spring 22 as an elastic member between the arm portion 19 and the base plate 12. The spring 22 elastically biases the lock lever 13 counterclockwise in FIG. 1 viewed from a side of an elevator shaft. The lock lever 13 further includes a stopper 23 that regulates a rotational range thereof.

As illustrated in FIG. 1, the other door panel 2b of the hall door apparatus 2 includes a latch portion 24 that can be engaged with and disengaged from the engaging portion 13b of the lock lever 13. In a normal condition in which the hall door apparatus 2 is closed, the lock lever 13 is maintained substantially horizontal, the engaging portion 13b engages with the latch portion 24, and thus the one door panel 2a and the other door panel 2b are coupled to each other and locked to maintain the closed door state.

As illustrated in FIGS. 1 and 2, in a state in which the lock lever 13 is maintained substantially horizontal, and the engaging portion 13b engages with the latch portion 24, the roller 21 supported by the shaft 20 is inclined toward one side with respect to a vertical line extending upward from the roller 17 supported by the shaft 14. Therefore, a line segment connecting a center of the shaft 14 to a center of the shaft 20 is inclined by an angle of θ toward a door stop side of the door panel 2a with respect to a vertical line passing through the center of the shaft 14. Then, in a state in which the roller 21 is inclined by an angle of θ from the roller 17, a distance W, which called “roller gap distance” hereinafter, between a vertical line that makes contact with an outer circumference of the roller 17 in the door opening direction and a vertical line that makes contact with an outer circumference of the roller 21 in the door closing direction is larger than a diameter of the roller 17.

The rollers 17 and 21 of the interlocking mechanism 11 are arranged at corresponding positions between the engaging vanes 3a and 3b of the engaging apparatus 3. In the normal condition in which the hall door apparatus 2 is closed, the distance W circumscribing the rollers is smaller than the gap L between the engaging vanes 3a and 3b, that is, W<L. When the car moves and the car door apparatus 1 opposes the hall door apparatus 2, the rollers 17 and 21 intervene between the engaging vanes 3a and 3b. In the case where the car passes this floor and travels toward an elevator hall of the next floor in this state, the engaging vanes 3a and 3b pass through between the rollers 17 and 21 without interference with the rollers at all because W<L.

The engaging vanes 3a and 3b of the engaging apparatus 3 include sheet-shaped friction members 26 and 27 as a friction generation mechanism at positions that can oppose the roller 17. These friction members 26 and 27 are formed of a material having a high coefficient of friction such as rubber.

Next, the operation of this embodiment will be described.

When the car travels to an elevator hall of a certain floor, and reaches the floor and stops there, as illustrated in FIG. 3, the car door apparatus 1 and the hall door apparatus 2 oppose each other, and the rollers 17 and 21 of the interlocking mechanism 11 intervene between the engaging vanes 3a and 3b. The door panels 1a and 1b of the car door apparatus 1 move in the door opening direction away from each other by a driving force of a driving source.

When the door panel 1a starts moving in the door opening direction, the one engaging vane 3a of the engaging apparatus 3 makes contact with the roller 21 of the interlocking mechanism 11, and the lock lever 13 rotates together with the roller 21 clockwise around the shaft 14 as illustrated in FIG. 3. As a result, the engaging portion 13b is disengaged from the latch portion 24, and the lock that couples the door panels 2a and 2b of the hall door apparatus 2 together is unlocked.

Almost at the same time, the guide roller 7 moves obliquely upward along the inclined portion 8b of the guide rail 8. The engaging vane 3b also makes a parallel movement upward together with the guide roller 7, and the engaging vane 3b approaches the engaging vane 3a through this parallel movement. When the gap L is narrowed, the rollers 17 and 21 of the interlocking mechanism 11 are held by the engaging vanes 3a and 3b therebetween so that the engaging apparatus 3 and the interlocking mechanism 11 engage with each other. The door panel 2a of the hall door apparatus 2 moves in the door opening direction together with the door panel 1a of the car door apparatus 1. The other door panel lb of the car door apparatus 1 moves, in an interlocking manner with the one door panel 1a, in the door opening direction opposite to the direction of the one door panel 1a. The other door panel 2b of the hall door apparatus 2 also moves, in an interlocking manner with the one door panel 2a, in the door opening direction opposite to the direction of the one door panel 2a.

Until the door panel 1a of the car door apparatus 1 moves in the door opening direction, the guide roller 7 shifts from the inclined portion 8b to the horizontal portion 8a of the guide rail 8, and rolls on the horizontal portion 8a. When the guide roller 7 moves to the horizontal portion 8a of the guide rail 8, the engaging vane 3b further rotates, and the gap L is further narrowed. As a result, the roller 17 is strongly clamped by the engaging vanes 3a and 3b therebetween.

The door opening operation completes and an open door state is maintained when each of the door panels 1a, 1b, 2a, and 2b reaches a predetermined door opened position. The passengers move for getting on and off between the car and the elevator hall in the open door state.

The roller 17 is strongly clamped by the pair of engaging vanes 3a and 3b therebetween while the door is open. The engaging vanes 3a and 3b have the friction members 26 and 27 in the portions opposing the roller 17. Accordingly, a strong frictional force is present between the roller 17 and the engaging vanes 3a and 3b. Since the roller 17 is strongly pressed against the friction members 26 by a force caused when the door panel 2a automatically closes, a stronger frictional force is generated therebetween.

The engaging vanes 3a and 3b are fastened to the car door apparatus 1, and the roller 17 as the engaging body is fitted to the hall door apparatus 2 which is vertically immovable. A movement of the car to vertically vibrate the car caused by a change in the load when the passengers get on and off the car is suppressed by a frictional force between the roller 17 and the friction members 26 and 27 of the engaging vanes 3a and 3b. As a result, the vertical vibration of the car does not occur substantially. Hence the passengers in the car can use the elevator with a feeling of security without feeling unsteady, weird or fear.

The door panels 1a and 1b of the car door apparatus 1 move together with the door panels 2a and 2b of the hall door apparatus 2 in the door closing direction by the force of the driving source when passengers have finished to get on and off the car. As the guide roller 7 reaches the inclined portion 8b of the guide rail 8 immediately before the door panels 1a and 1b close while they are moving, the guide roller 7 moves obliquely downward along the inclined portion 8b together with the engaging vane 3b mainly by the own weight of the engaging vane 3b.

The gap L between the engaging vanes 3a and 3b is widened and the rollers 17 and 21 are released from clamping by them, because the guide roller 7 moves downward. Immediately after this, door stop side end portions of the door panels 1a and 1b of the car door apparatus 1 abut each other and stop. Further, the door panels 2a and 2b of the hall door apparatus 2 move in the door closing direction by their own closing action, and the door panels 2a and 2b stop when door stop side end portions abut each other.

The gap L between the engaging vanes 3a and 3b is widened when the door stop side end portions of the door panels 2a and 2b of the hall door apparatus 2 abut each other. The lock lever 13 of the interlocking mechanism 11 rotates together with the roller 21 around the shaft 14 counterclockwise, when viewed from the car, by an action of an elastic force of the spring 22.

The engaging portion 13b of the lock lever 13 engages with the latch portion 24, and thus the door panels 2a and 2b are locked while they are coupled to each other. The door closing operation completes through this procedure. Thereafter, the car travels to a next destination floor.

In this first embodiment, the friction members 26 and 27 are attached to both of the engaging vanes 3a and 3b of the engaging apparatus 3, respectively. However, it is also possible to attach the friction member, serving as a friction generation mechanism, to only one of the engaging vanes 3a and 3b.

Further, a material of the roller 17 may be formed of a material having a high coefficient of friction such as rubber as the friction generation mechanism instead of using the friction members. In this case, the frictional force between the roller 17 and the engaging vanes 3a and 3b is increased by a frictional function of the roller 17 so that the vertical vibration of the car can be suppressed.

Further, in this case, a material having a high coefficient of friction may be used as an entire material of the roller 17, or a material on the outer circumference of the roller 17 which makes contact with the engaging vanes 3a and 3b may be formed of a material having a high coefficient of friction. Alternatively, a material having a high coefficient of friction may be used as a material of the roller 17, and additional friction members may be attached to both or one of the engaging varies 3a and 3b.

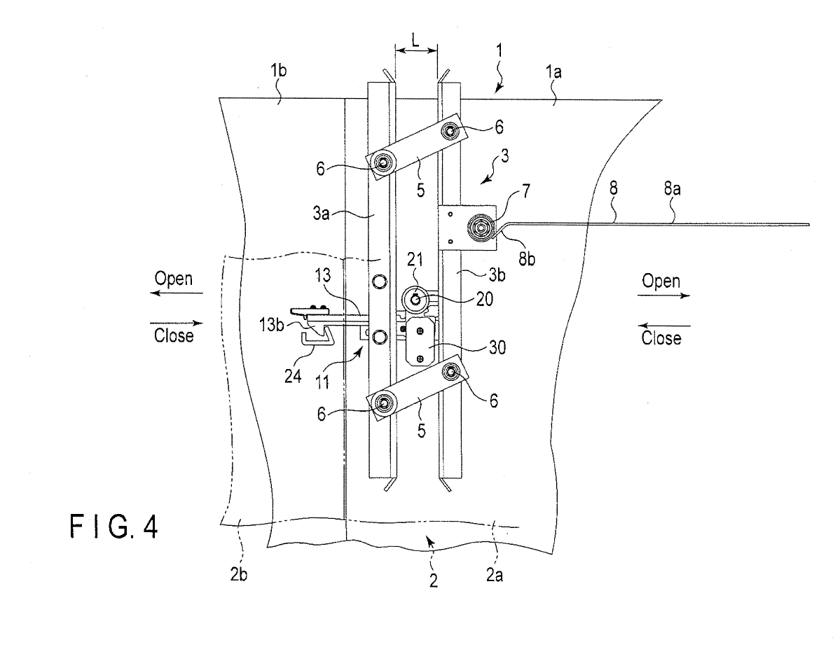

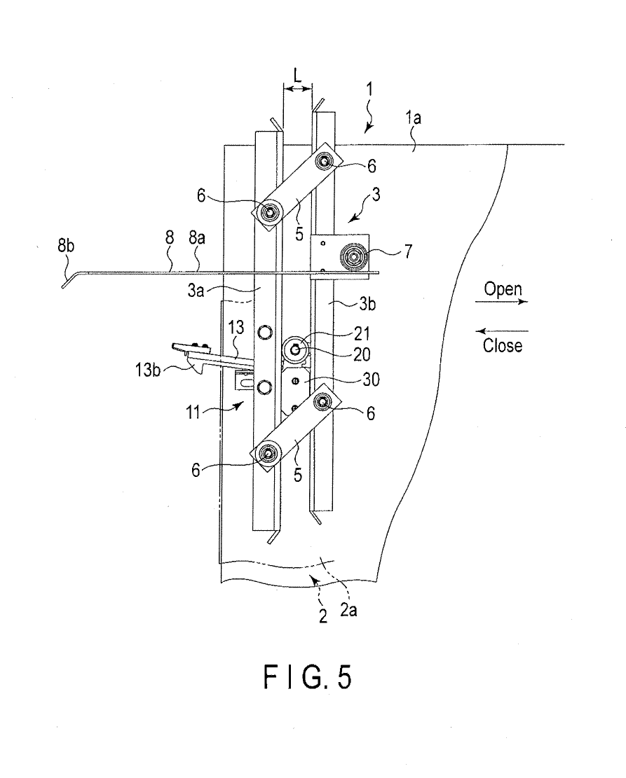

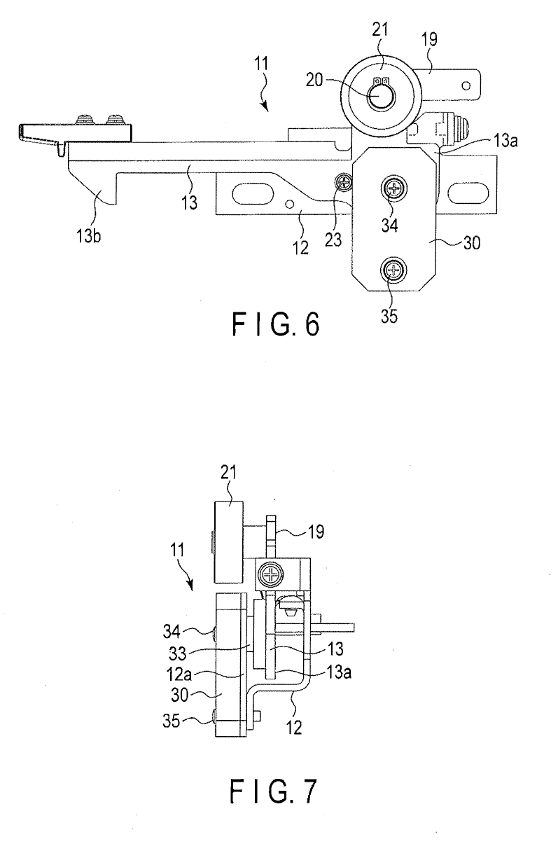

FIGS. 4 to 7 illustrate a second embodiment. In this embodiment, instead of the roller 17 of the interlocking mechanism 11 according to the first embodiment, a block-shaped friction member 30 as an engaging body is detachably attached to the base plate 12. The friction member 30 functions not only as the engaging body of the interlocking mechanism 11, but also as a friction generation mechanism. The friction member 30 is formed of a material having a high coefficient of friction such as rubber, and is in a rectangular shape vertically elongated. The friction member 30 is placed beneath the roller 21.

In this embodiment, as illustrated in FIG. 7, the base plate 12 has a support portion 12a. The support portion 12a has a shaft 33. The proximal portion 13a of the lock lever 13 is rotatably supported by this shaft 33. The friction member 30 is detachably fastened to the support portion 12a by a pair of screws 34 and 35. The one screw 34 penetrates through the friction member 30, and is screwed into the shaft 33. The other screw 35 penetrates through the friction member 30, and is screwed into the support portion 12a. The friction member 30 can be detached from the support portion 12a when these screws 34 and 35 are removed.

In the case of this embodiment, when the door panel 1a moves in the door opening direction from the closed door state illustrated in FIG. 4, the guide roller 7 of the engaging vane 3b moves obliquely upward along the inclined portion 8b of the guide rail 8. As a result, the engaging vane 3b is pushed upward, and the gap L between the engaging vanes 3a and 3b is narrowed as illustrated in FIG. 5.

The roller 21 of the interlocking mechanism 11 rotates clockwise together with the lock lever 13 around the shaft 33 illustrated in FIG. 7 when the gap L between the engaging vanes 3a and 3b is narrowed. A locking condition by the lock lever 13 with the hall door apparatus 2 is released. The engaging vane 3b is pressed against the friction member 30. The friction member 30 is held by the engaging vanes 3a and 3b therebetween.

While this state is maintained, the door panels 1a, 1b, 2a, and 2b move in the door opening direction to a predetermined door opened position and stop there. As a result, the door opening operation completes. In this state, the passengers move for getting on and off between the car and the elevator hall.

The friction material 30 provided in the hall door apparatus 2 is pressed and held by the engaging vanes 3a and 3b provided in the car door apparatus 1. Therefore, a large frictional force is generated between the friction member 30 and the engaging vanes 3a and 3b. Accordingly, the vertical vibration caused by embarkation and disembarkation of the passengers is suppressed by this frictional force. Since the vertical vibration of the car does not occur substantially, hence the passengers in the car can use the elevator with a feeling of security without feeling weird or fear.

After passengers have finished to get on and off to the car, the door panels 1a and 1b of the car door apparatus 1 move together with the door panels 2a and 2b of the hall door apparatus 2 in the door closing direction by a driving force of the driving source. Then, the guide roller 7 reaches the inclined portion 8b of the guide rail 8 immediately before the door panels 1a and 1b close while they are moving. The guide roller 7 moves obliquely downward along the inclined portion 8b together with the engaging vane 3b mainly by the own weight of the engaging vane 3b.

As the engaging bane 3b moves downward, the gap L between the engaging vanes 3a and 3b is widened, and the friction member 30 and the roller 21 are released from a state of being held. Immediately after this, the door stop side end portions of the door panels 1a and 1b of the car door apparatus 1 abut each other and stop. Further, the door panels 2a and 2b of the hall door apparatus 2 move in the door closing direction by their own closing force, and the door panels 2a and 2b stop when door stop side end portions thereof abut each other.

The gap L between the engaging vanes 3a and 3b is widened, and the lock lever 13 of the interlocking mechanism 11 rotates counterclockwise together with the roller 21 around the shaft 33 by an elastic force of the spring 22, when the door stop side end portions of the door panels 2a and 2b of the hall door apparatus 2 abut each other. The engaging portion 13b of the lock lever 13 engages with the latch portion 24, and thus the door panels 2a and 2b are locked while they are coupled to each other. The door closing operation completes through this procedure. Thereafter, the car travels to a next destination floor.

The friction member 30 is detachably attached to the support portion 12a of the base plate 12. Accordingly, in the case where the friction member 30 deteriorates, the friction member 30 may be removed and be easily replaced with another new friction member 30.

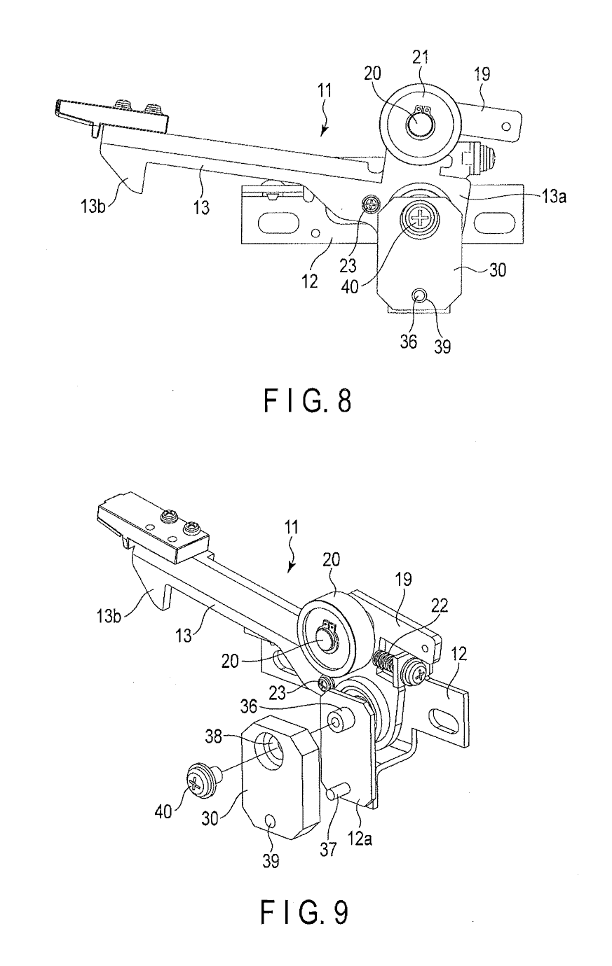

FIGS. 8 and 9 illustrate a third embodiment. Although the friction member 30 is attached to the support portion 12a of the base plate 12 using a rigid structure in the second embodiment, the friction member 30 may be attached using a flexible structure as in the case of the third embodiment illustrated in FIGS. 8 and 9. In the third embodiment, as illustrated in FIG. 9, a support shaft 36 and a support pin 37 are provided integrally with the support portion 12a of the base plate 12. The friction member 30 has a through-hole 38 having an inner diameter that is slightly larger than an outer diameter of the support shaft 36, and a through-hole 39 having an inner diameter that is slightly larger than an outer diameter of the support pin 37. The through-hole 38 is loosely fitted to the support shaft 36, and the through-hole 39 is loosely fitted to the support pin 37. A screw 40 for prevention of dropping off is screwed into an end face of the support shaft 36. The screw 40 does not fasten the friction member 30, but is fitted merely for preventing the friction member 30 from dropping off. Therefore, the friction member 30 is supported by the support shaft 36 and the support pin 37 with clearance allowing the friction member 30 to be freely displaced vertically and horizontally with respect to the support shaft 36 and the support pin 37.

In the case of this embodiment, the gap L between the engaging vanes 3a and 3b is narrowed so that the engaging vanes 3a and 3b hold the friction member 30 therebetween while the door is closed. The friction member 30 is swingably displaced in response to the tilting of the engaging vanes 3a and 3b, even if the engaging vanes 3a and 3b tilt, and an offset load is applied to the friction member 30. Since the engaging vanes 3a and 3b make close contact with the friction member 30 properly and uniformly, a strong frictional force is obtained regardless of the tilting of the engaging vanes 3a and 3b.

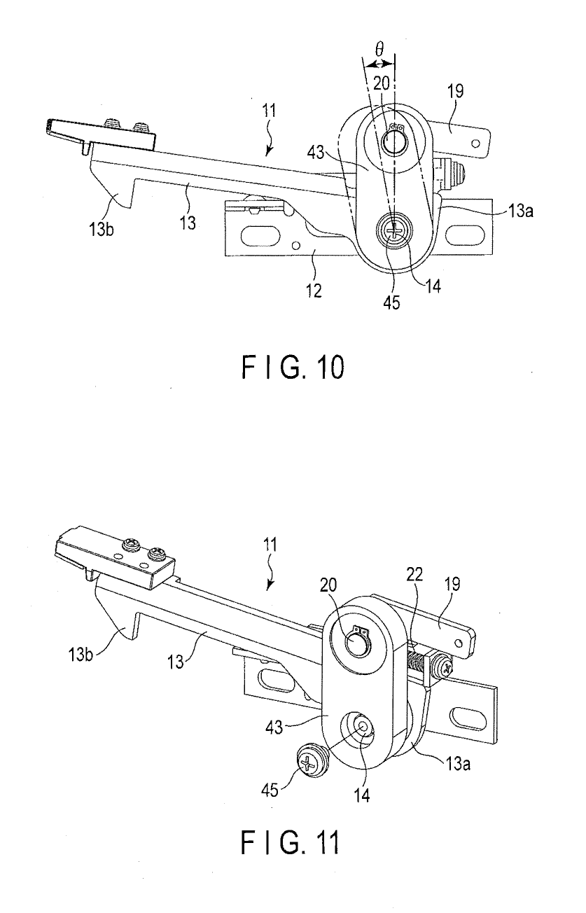

FIGS. 10 and 11 illustrate a fourth embodiment. In this embodiment, the lock lever 13 of the interlocking mechanism 11 includes a friction member 43 over a range from the shaft 14 that rotatably supports the proximal portion 13a to the shaft 20 fastened to the arm portion 19 of the lock lever 13.

The friction member 43 functions as an engaging body of the interlocking mechanism 11 and as a friction generation mechanism as well. The friction member 43 is formed of a material having a high coefficient of friction such as rubber. The friction member 43 has a circumference in a semicircular shape on each side of the shaft 14 and the shaft 20, and side faces with parallel flat surfaces, and thus it is substantially an elliptical shape. One end portion of the friction member 43 is mounted on the shaft 14, and the other end portion thereof is mounted on the shaft 20. In addition, a screw 45 for preventing the friction member 43 from dropping off is screwed into an end face of the shaft 14.

While the lock lever 13 is held almost horizontally, and the engaging portion 13b engages with the latch portion 24, the friction member 43 is inclined by an angle of θ toward the door stop side of the door panel 2a with respect to a vertical line passing through the shaft 14 as illustrated in FIG. 10 by alternate long and two short dashes line.

In the case of this embodiment, the guide roller 7 of the engaging vane 3b moves obliquely upward along the inclined portion 8b of the guide rail 8 when the door panel 1a moves in the door opening direction from the closed door state. As a result, the engaging vane 3b rotates in a manner to be pushed upward, and the gap L between the engaging vanes 3a and 3b is narrowed. The friction member 43 in an inclined state is held by the engaging vanes 3a and 3b therebetween, and rotates clockwise around the shaft 14 together with the lock lever 13 by the pressing force thereof. The lock lever 13 unlocks the hall door apparatus 2. The friction member 43 stands upright vertically for aligning the shaft 14 and the shaft 20 vertically. The engaging vanes 3a and 3b are pressed against the both side faces of the friction member 30.

While this state is maintained, the door panels 1a, 1b, 2a, and 2b move in the door opening direction to a predetermined door opened position and stop there. Then the door opening operation completes. In this stale, the passengers move to get on and off between the car and the elevator hall.

Since the friction material 43 provided in the hall door apparatus 2 is pressed and held by the engaging vanes 3a and 3b provided in the car door apparatus 1, a large frictional force is generated between the friction member 43 and the engaging vanes 3a and 3b. The vertical vibration caused by embarkation and disembarkation of the passengers is suppressed by the frictional force. The vertical vibration of the car does not occur substantially, and thus the passengers in the car can use the elevator with a feeling of security without feeling weird or fear.

After the passengers finished to get on and off to the car, the door panels 1a and 1b of the car door apparatus 1 move together with the door panels 2a and 2b of the hall door apparatus 2 in the door closing direction by a driving force of the driving source. When the guide roller 7 reaches the inclined portion 8b of the guide rail 8 immediately before the door panels 1a and 1b of the car door apparatus 1 are closed, the guide roller 7 moves obliquely downward along the inclined portion 8b together with the engaging vane 3b mainly by the own weight of the engaging vane 3b.

The gap L between the engaging vanes 3a and 3b is widened, and the friction member 43 is released from a state of being held, when the engaging bane 3b moves downward. Immediately after this, the door stop side end portions of the door panels 1a and 1b of the car door apparatus 1 abut each other and stop. Further, the door panels 2a and 2b of the hall door apparatus 2 move in the door closing direction by their own closing force, and the door panels 2a and 2b stop when door stop side end portions thereof abut each other.

The gap L between the engaging vanes 3a and 3b is widened, and the lock lever 13 of the interlocking mechanism 11 rotates counterclockwise around the shaft 14 together with the friction member 43 by an elastic force of the spring 22, When the door stop side end portions of the door panels 2a and 2b of the hall door apparatus 2 abut each other. Since the engaging portion 13b of the lock lever 13 engages with the latch portion 24, the door panels 2a and 2b are coupled to each other and locked. The door closing operation completes through this procedure. Thereafter, the car travels to a next destination floor.

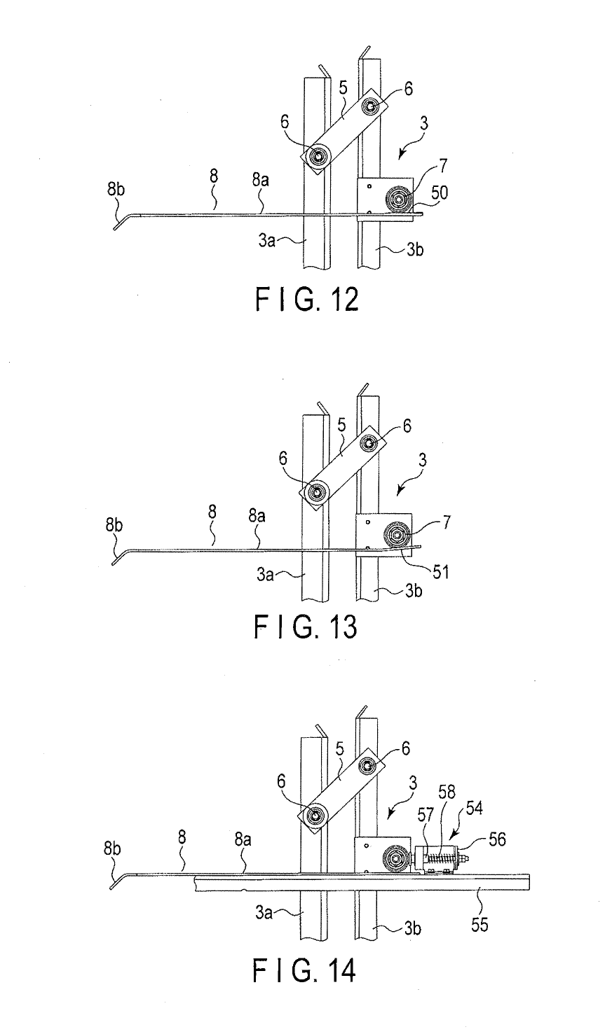

According to the first to fourth embodiments, the guide roller 7 of the engaging vane 3b is moved upward along the inclined portion 8b of the guide rail 8 when the door opening operation starts. Since the guide roller 7 runs on the horizontal portion 8a, the gap L between the engaging vanes 3a and 3b is narrowed. With this arrangement, the engaging body of the interlocking mechanism 11 is held by the engaging vanes 3a and 3b therebetween to generate a frictional force. Alternatively, as in the case of fifth to seventh embodiments illustrated in FIGS. 12 to 14, it is also possible to provide a frictional force increasing mechanism that increases a frictional force between the guide roller 7 and the engaging vanes 3a and 3b at a position where the door opening operation completes, i.e., where the door panels are completely opened.

FIG. 12 illustrates a fifth embodiment. In the fifth embodiment, a step 50 as a frictional force increasing mechanism, which is elevated from the horizontal portion 8a of the guide rail 8, is provided at an end portion of the guide rail 8 opposite to the inclined portion 8b, i.e., a portion where the guide roller 7 reaches when the door opening operation completes.

In this embodiment, since the guide roller 7 moves upward along the inclined portion 8b of the guide rail 8 when the door opening operation starts, the gap L between the engaging vanes 3a and 3b is narrowed, and the engaging vanes 3a and 3b hold the engaging body therebetween. Hence, the car door apparatus 1 and the hall door apparatus 2 engage with each other. Immediately before the door opening operation completes, the guide roller 7 runs on the step 50 of the guide rail 8. Thus, the door opening operation completes. The engaging vane 3b rotates in a manner to be pushed further upward, and the gap L between the engaging vanes 3a and 3b is further narrowed, when the guide roller 7 runs on the step 50 of the guide rail 8. Since the engaging vanes 3a and 3b strongly press the engaging body, the frictional force between the engaging body and the engaging vanes 3a and 3b increases. The vertical vibration of the car is more securely suppressed when the frictional force increases.

FIG. 13 illustrates a sixth embodiment. In the sixth embodiment, a slope 51 as a frictional force increasing mechanism is formed at a door opening side end portion of the guide rail 8. The slope 51 is an inclined surface at the door opening side end portion, which is gradually elevating toward a direction opposite to that of the inclined portion 8b, i.e., gradually elevating obliquely upward from the horizontal portion 8a.

According to this embodiment, since the guide roller 7 moves upward along the inclined portion 8b of the guide rail 8 when the door opening operation starts, the gap L between the engaging vanes 3a and 3b is narrowed, and the engaging vanes 3a and 3b hold the engaging body therebetween. Therefore, the car door apparatus 1 and the hall door apparatus 2 engage with each other. Immediately before the door opening operation completes, the guide roller 7 runs on the slope 51 of the guide rail 8. Thus, the door opening operation completes. The engaging vane 3b rotates to be pushed further upward, and the gap L between the engaging vanes 3a and 3b is further narrowed, when the guide roller 7 runs on the slope 51 of the guide rail 8. The engaging vanes 3a and 3b and the engaging body are strongly pressed against each other, and thus the frictional force between the engaging body and the engaging vanes 3a and 3b increases. The vertical vibration of the car is more securely suppressed because the frictional force increases.

FIG. 14 illustrates a seventh embodiment. In the seventh embodiment, a pressing apparatus 54 as a frictional force increasing mechanism is provided at the door opening side end portion of the guide rail 8. The pressing apparatus 54 is provided with a frame 56 mounted on a door frame member 55 of the car, a push rod 57 provided with the frame 56 movably in a horizontal direction, and a spring 58 that elastically biases the push rod 57 along the guide rail 8 in the door closing direction. A front end portion of the push rod 57 protrudes from the frame 56 and is positioned above the door opening side end portion of the guide rail 8. When the guide roller 7 reaches the door opening side end portion of the guide rail 8, the guide roller 7 makes contact with the front end portion of the push rod 57, and further pushes in the push rod 57 against the elastic force of the spring 58.

According to this embodiment, since the guide roller 7 moves upward along the inclined portion 8b of the guide rail 8 when the door opening operation starts, the gap L between the engaging vanes 3a and 3b is narrowed, and the engaging vanes 3a and 3b hold the engaging body therebetween. Thus, the car door apparatus 1 and the hall door apparatus 2 engage with each other. Immediately before the door opening operation completes, the guide roller 7 pushes in the push rod 57 against the elastic force of the spring 58. In this way, the door opening operation completes.

A reaction force caused when the guide roller 7 pushes in the push rod 57 against the elastic force of the spring 58 is applied to the guide roller 7. This means that the guide roller 7 receives a pressing force to be elastically pressed in the door closing direction. This pressing force makes the engaging vane 3b rotate and push upward, and acts as an elastic force in a direction to narrow the gap L between the engaging vanes 3a and 3b. This elastic force allows the engaging vanes 3a and 3b and the engaging body to be strongly pressed against each other, therefore the frictional force between the engaging body and the engaging vanes 3a and 3b increases. The vertical vibration of the car is more securely suppressed because the frictional force increases.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A vibration damping apparatus for an elevator car comprising:
an engaging apparatus configured to be provided in a car door apparatus of an elevator and to be comprising a pair of engaging vanes opposing each other, the pair of engaging vanes having a gap therebetween which is narrowed when the car door apparatus opens and is widened when the car door apparatus closes;
an interlocking mechanism configured to be provided in a hall door apparatus of the elevator and to be comprising: a lock lever which is freely rotatable and locks a door closing state of the hall door apparatus; and an engaging body which intervenes between the pair of engaging vanes when the car door apparatus opposes the hall door apparatus; the interlocking mechanism allowing to disengage the lock lever and to interlock an operation of the hall door apparatus with an operation of the car door apparatus thereafter by operation in which the pair of engaging vanes narrow the gap therebetween and hold the engaging body when the car door apparatus starts door opening operation; and
a friction generation mechanism configured to generate a frictional force, which suppresses a vertical vibration of the elevator car, between the engaging body and at least one of the pair of engaging vanes while the pair of engaging vanes is in an engaging state with the engaging body by holding the engaging body therebetween.

2. The vibration damping apparatus for an elevator car of claim 1, wherein
the engaging body comprises a roller that is freely rotatable and is held between the pair of engaging varies, and
the friction generation mechanism comprises a friction member provided at a portion of the at least one of the pair of engaging vanes which makes contact with the roller, and generates the frictional force between the at least one of the pair of engaging vanes and the roller for suppressing the vertical vibration of the elevator car by the friction member.

3. The vibration damping apparatus for an elevator car of claim 1, wherein
the engaging body comprises a roller that is freely rotatable and is held between the pair of engaging vanes, and
the friction generation mechanism comprises a material having a high coefficient of friction as a material forming at least a surface of the roller, and generates the frictional force between the pair of engaging vanes and the roller for suppressing the vertical vibration of the elevator car by the material.

4. The vibration damping apparatus for an elevator car of claim 1, wherein
the engaging body comprises a friction member as the friction generation mechanism configured to be formed in a block shape and to be attached to the interlocking mechanism, and
the friction member generates the frictional force for suppressing the vertical vibration of the elevator car by being held between the pair of engaging vanes therebetween.

5. The vibration damping apparatus for an elevator car of claim 4, wherein
the friction member is configured to be attached to the interlocking mechanism detachably.

6. The vibration damping apparatus for an elevator car of claim 5, wherein
the friction member is configured to be attached to the interlocking mechanism swingably.

7. The vibration damping apparatus for an elevator car of claim 1, wherein
the engaging apparatus comprising: a guide roller configured to be attached to one of the pair of engaging vanes; a guide rail configured to be guiding the guide roller when the car door apparatus is in opening and closing operation; and a frictional force increasing mechanism configured to be provided to the guide rail and to be increasing a frictional force between the engaging body and the at least one of the pair of engaging vanes when the door opening operation of the car door apparatus completes.

8. The vibration damping apparatus for an elevator car of claim 7, wherein
the frictional force increasing mechanism comprises a step provided at an end portion of the guide rail, and increases the frictional force between said at least one of the pair of engaging vanes and the engaging body by making the guide roller run up the step and by narrowing a gap between the pair of engaging vanes, when the door opening operation of the car door apparatus completes.

9. The vibration damping apparatus for an elevator car of claim 7, wherein
the frictional force increasing mechanism comprises a slope provided at an and portion of the guide rail, and increases the frictional force between the at least one ob the pair of engaging vanes and the engaging body by making the guide roller run up the slope and by narrowing a gap between the pair of engaging vanes, when the door opening operation of the car door apparatus completes.

10. The vibration damping apparatus for an elevator car of claim 7, wherein
the frictional force increasing mechanism comprises a pressing apparatus mounted at an end portion of the guide rail, and
the pressing apparatus comprises a push rod configured to be provided with an elastic biasing force by a spring, assists a force of the pair of engaging vanes holding the engaging body therebetween with the biasing force of the push rod when the door opening operation of the car door apparatus completes, and increases the frictional force between the at least one of the pair of engaging vanes and the engaging body.
